(19) United States
(12) Patent Application Publication
(10) Pub. No.: US 2026/0255309 A1
(43) Pub. Date: Aug. 27, 2026

(54) USER EQUIPMENT CONFIGURED FOR SIDELINK POSITIONING REFERENCE SIGNAL (SL-PRS) MEASUREMENT AND REPORTING

(71) Applicant: Intel Corporation, Santa Clara, CA (US)

(72) Inventors: Rui Huang, Beijing (CN); Andrey Chervyakov, Maynooth (IE); Hua Li, Beijing 11 (CN); In-Seok Hwang, Santa Clara, CA (US); Meng Zhang, Beijing (CN)

(21) Appl. No.: 19/162,834

(22) PCT Filed: Apr. 5, 2024
(86) PCT No.: PCT/US2024/023277

§ 371 Date: Sep. 5, 2025

Related U.S. Application Data
(60) Provisional application No. 63/494,650, filed on Apr. 6, 2023.

(51) Int. Cl. H04W 64/00; H04W 92/18

(52) U.S. Cl. CPC H04W 64/00; H04W 92/18

(57) ABSTRACT

A user equipment (UE) configured for operation in a fifth-generation new radio (5G NR) network that is capable of performing sidelink (SL) po-gNB sitioning measurements may decode a sidelink configuration information (SCI) received from a generation Node B (gNB). The SCI may include an information element that indicates configuration information for resources of a sidelink positioning reference signal (SL PRS) resource pool. The UE may measure sidelink (SL) positioning reference signal (SL PRS) resources received from another UE based on the configuration information and may report measurements of the SL PRS resources within a measurement reporting delay time. The UE may be configured to report the measurements in a measurement report to the other UE or a location management function (LMF) of the network.

### PRIORITY CLAIM

This application claims priority to United States Provisional Patent Application Ser. No. 63/494,650, filed Apr. 6, 2023 [reference number AF2957-Z] which is incorporated herein by reference in its entirety.

### TECHNICAL FIELD

Embodiments pertain to wireless communications.

### BACKGROUND

Mobile communications have evolved significantly from early voice systems to today's highly sophisticated integrated communication platform. With the increase in different types of devices communicating with various network devices, usage of 3GPP 5G NR systems has increased. The penetration of mobile devices (user equipment or UEs) in modern society has continued to drive demand for a wide variety of networked devices in many disparate environments. 5G NR wireless systems are forthcoming and are expected to enable even greater speed, connectivity, and usability, and are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

One issue with 5G NR networks is sidelink communications, which allow devices to communicate directly with each other without using a network.

### BRIEF DESCRIPTION OF THE DRAWINGS

FIG. 1A illustrates an architecture of a network, in accordance with some embodiments.

FIG. 1B and FIG. 1C illustrate a non-roaming 5G system architecture in accordance with some embodiments.

FIG. 2 is a functional block diagram of a wireless communication device, in accordance with some embodiments; and

FIG. 3 illustrates sidelink communications, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments are directed to a user equipment (UE) configured for operation in a fifth-generation new radio (5G NR) network. In these embodiments, the UE may be capable of performing sidelink (SL) positioning measurements. In these embodiments, for performing the SL positioning measurements, the UE may decode a sidelink configuration information (SCI) received from a generation Node B (gNB). The SCI may include an information element that indicates configuration information for resources of a sidelink positioning reference signal (SL PRS) resource pool. The UE may also measure sidelink (SL) positioning reference signal (SL PRS) resources received from another UE based on the configuration information and may report measurements of the SL PRS resources within a measurement reporting delay time. The UE may be configured to report the measurements in a measurement report to the other UE or a location management function (LMF) of the network. These embodiments as well as others are described in more detail below.

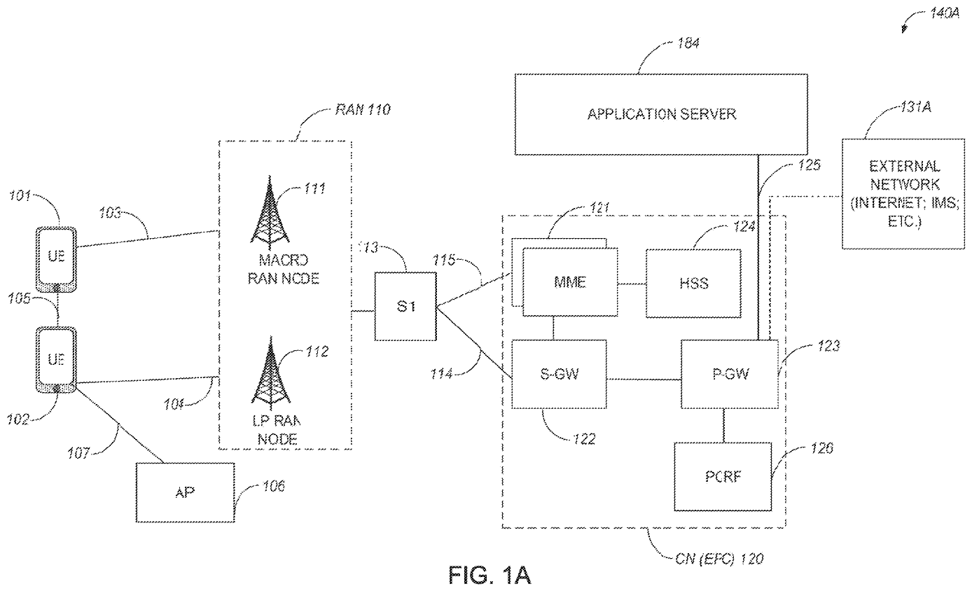

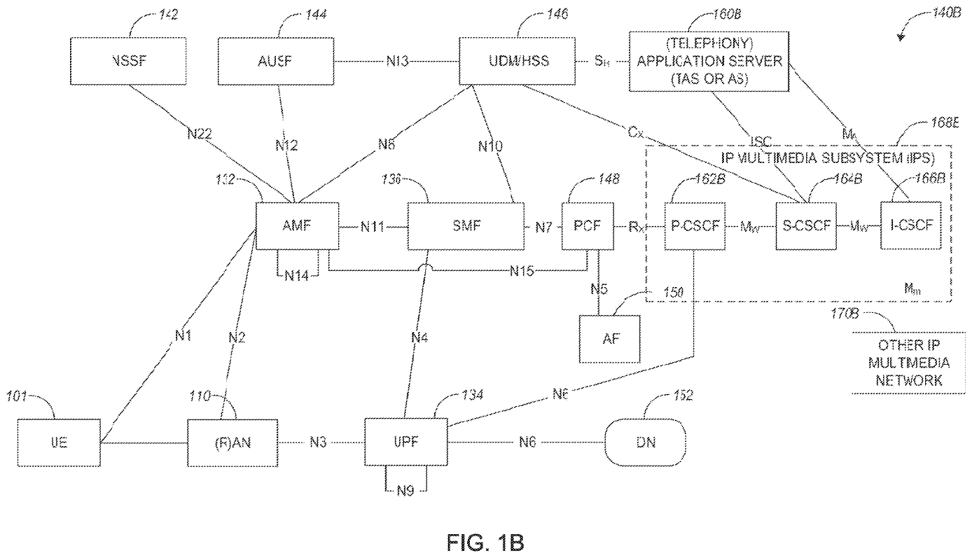

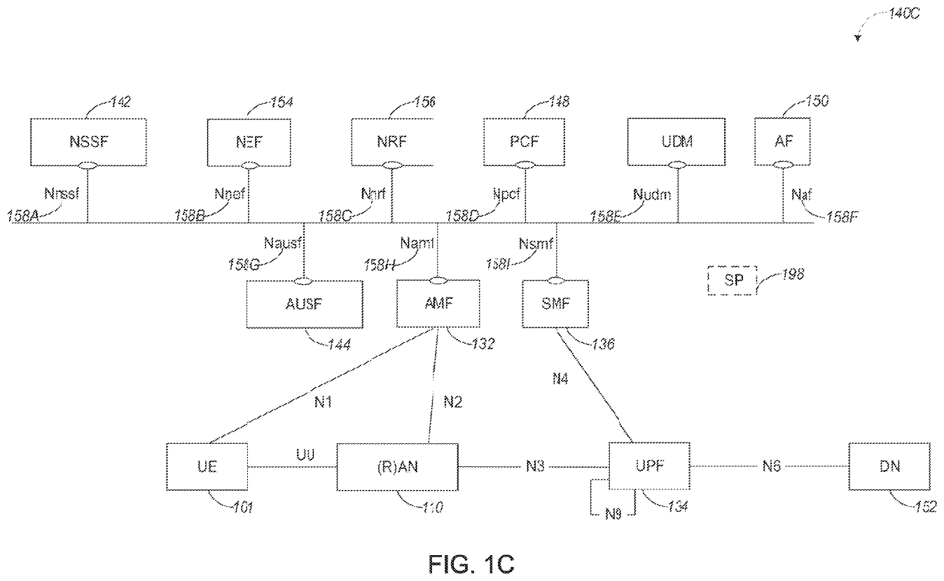

FIG. 1A illustrates an architecture of a network in accordance with some embodiments. The network 140A is shown to include user equipment (UE) 101 and UE 102. The UE 101 and UE 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UE 101 and UE 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some embodiments, carrier aggregation may be used where one or more component carriers operate on unlicensed frequencies.

Embodiments described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHZ and further frequencies).

Embodiments described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some embodiments, any of the UE 101 and UE 102 can comprise an Internet-of-Things (IoT) UE or a Cellular IoT (CIoT) UE, which can comprise a network access layer designed for low-power IoT applications utilizing short-lived UE connections. In some embodiments, any of the UE 101 and UE 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some embodiments, any of the UE 101 and UE 102 can include enhanced MTC (eMTC) UEs or further enhanced MTC (FeMTC) UEs.

The UE 101 and UE 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UE 101 and UE 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UE 101 and UE 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some embodiments, the RAN nodes 111 and 112 can be transmission/reception points (TRPs). In instances when the RAN nodes 111 and 112 are NodeBs (e.g., eNBs or gNBs), one or more TRPs can function within the communication cell of the NodeBs. The RAN 110 may include one or more RAN nodes for providing macrocells, e.g., macro-RAN node, and one or more RAN nodes for providing femtocells or picocells (e.g., cells having smaller coverage areas, smaller user capacity, or higher bandwidth compared to macrocells), e.g., low power (LP) RAN node.

Any of the RAN nodes 111 and 112 can terminate the air interface protocol and can be the first point of contact for the UE 101 and UE 102. In some embodiments, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the RAN nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In embodiments, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility embodiments in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UE 101 and UE 102 via the CN 120.

The P-GW 123 may further be a node for policy enforcement and charging data collection. Policy and Charging Rules Function (PCRF) 126 is the policy and charging control element of the CN 120. In a non-roaming scenario, in some embodiments, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some embodiments, the communication network 140A can be an IoT network or a 5G network, including 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC). In these embodiments, the RAN 110 can include a plurality of nodes, such as gNBs and NG-eNBs. The CN 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some embodiments, the gNBs and the NG-eNBs can be connected to the AMF by NGC interfaces, and to the UPF by NG-U interfaces. The gNBs and the NG-eNBs can be coupled to each other via Xn interfaces.

In some embodiments, the NG system architecture can use reference points between various nodes as provided by 3GPP Technical Specification (TS) 23.501 (e.g., V15.4.0, 2018-12). In some embodiments, each of the gNBs and the NG-eNBs can be implemented as a base station, a mobile edge server, a small cell, a home eNB, and so forth. In some embodiments, a gNB can be a master node (MN) and NG-eNB can be a secondary node (SN) in a 5G architecture.

FIG. 1B illustrates a non-roaming 5G system architecture in accordance with some embodiments. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some embodiments, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain embodiments of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some embodiments, the I-CSCF 166B can be connected to another IP multimedia network 170E, e.g. an IMS operated by a different network operator.

In some embodiments, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM/HSS 146 and the AMF 132, not shown), N9 (between two UPFs 134, not shown), N10 (between the UDM/HSS 146 and the SMF 136, not shown), N11 (between the AMF 132 and the SMF 136, not shown), N12 (between the AUSF 144 and the AMF 132, not shown), N13 (between the AUSF 144 and the UDM/HSS 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some embodiments, 5G system architectures can be service-based and interaction between network functions can be represented by corresponding point-to-point reference points Ni or as service-based interfaces.

In some embodiments, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM/HSS 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

In some embodiments, any of the UEs or base stations described in connection with FIGS. 1A-1C can be configured to perform the functionalities described herein.

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that targets to meet vastly different and sometimes conflicting performance dimensions and services. Such diverse multi-dimensional requirements are driven by different services and applications. In general, NR will evolve based on 3GPP LTE-Advanced with additional potential new Radio Access Technologies (RATs) to enrich people's lives with better, simple, and seamless wireless connectivity solutions. NR will enable everything connected by wireless and deliver fast, rich content and services.

Rel-15 NR systems are designed to operate on the licensed spectrum. The NR-unlicensed (NR-U), a short-hand notation of the NR-based access to unlicensed spectrum, is a technology that enables the operation of NR systems on the unlicensed spectrum.

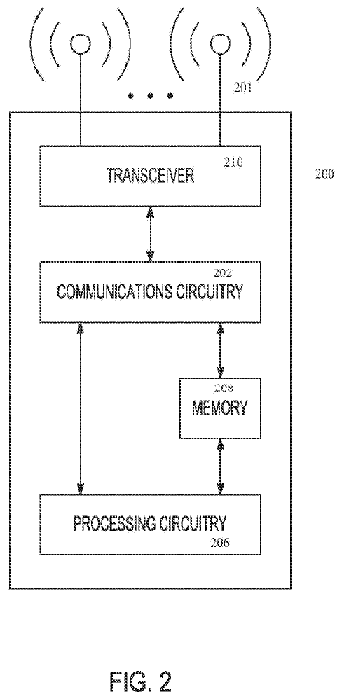

FIG. 2 illustrates a functional block diagram of a wireless communication device, in accordance with some embodiments. Wireless communication device 200 may be suitable for use as a UE or gNB configured for operation in a 5G NR or 6G network. Some embodiments are directed to an apparatus of a UE or gNB comprising processing circuitry and memory configured for operation in a 5G NR or 6G network.

The wireless communication device 200 may include communications circuitry 202 and a transceiver 210 for transmitting and receiving signals to and from other communication devices using one or more antennas 201. The communications circuitry 202 may include circuitry that can operate the physical layer (PHY) communications and/or medium access control (MAC) communications for controlling access to the wireless medium, and/or any other communications layers for transmitting and receiving signals. The wireless communication device 200 may also include processing circuitry 206 and memory 208 arranged to perform the operations described herein. In some embodiments, the communications circuitry 202 and the processing circuitry 206 may be configured to perform operations detailed in the above figures, diagrams, and flows.

In accordance with some embodiments, the communications circuitry 202 may be arranged to contend for a wireless medium and configure frames or packets for communicating over the wireless medium. The communications circuitry 202 may be arranged to transmit and receive signals. The communications circuitry 202 may also include circuitry for modulation/demodulation, upconversion/downconversion, filtering, amplification, etc. In some embodiments, the processing circuitry 206 of the wireless communication device 200 may include one or more processors. In other embodiments, two or more antennas 201 may be coupled to the communications circuitry 202 arranged for sending and receiving signals. The memory 208 may store information for configuring the processing circuitry 206 to perform operations for configuring and transmitting message frames and performing the various operations described herein. The memory 208 may include any type of memory, including non-transitory memory, for storing information in a form readable by a machine (e.g., a computer). For example, the memory 208 may include a computer-readable storage device, read-only memory (ROM), random-access memory (RAM), magnetic disk storage media, optical storage media, flash-memory devices and other storage devices and media.

In some embodiments, the wireless communication device 200 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the wireless communication device 200 may include one or more antennas 201. The antennas 201 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting device.

In some embodiments, the wireless communication device 200 may include one or more of a keyboard, a display, a non-volatile memory port, multiple antennas, a graphics processor, an application processor, speakers, and other mobile device elements. The display may be an LCD screen including a touch screen.

Although the wireless communication device 200 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the wireless communication device 200 may refer to one or more processes operating on one or more processing elements.

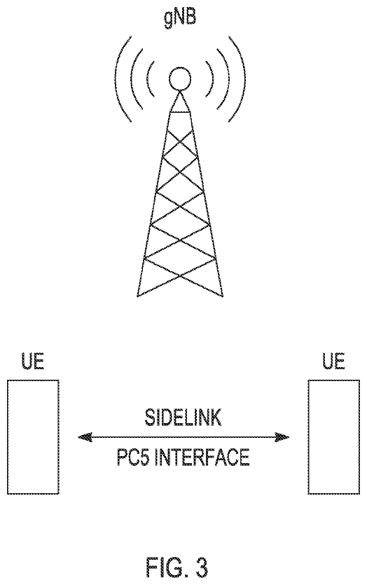

FIG. 3 illustrates sidelink communications, in accordance with some embodiments. Sidelink communication is a technology that allows cellular devices to communicate directly with each other without using a network. It's a core topology of the 5G system design and can operate in different spectrum configurations. In accordance with embodiments, sidelink positioning reference signals (SL PRS) are generated and transmitted by the UE (User Equipment), not the gNB (i.e., a next-generation Node B or a 5G base station). In these embodiments, SL PRS are specifically designed for direct device-to-device (D2D) positioning between UEs without involving the gNB. The UE transmitting the SL PRS acts as a sort of “anchor” or reference point, allowing other nearby UEs to estimate their relative position by measuring the SL PRS. This is part of the 5G positioning framework, which includes different methods for determining the location of devices. While some positioning methods rely on signals from the gNB (like the PRS transmitted by the gNB in downlink), the SL PRS is a key component of the sidelink positioning capability that allows UEs to directly locate each other without needing to communicate through the gNB.

Sidelink communication is attractive for uses that require ultra-low latency and high reliability data connectivity. It's used by the emergency first responder community and has been around since 3GPP Release 12. Sidelink communication allows devices like cars, robots, and consumer gadgets to create their own ad hoc networks. It turns User Equipment (UE), such as mobile devices, into a proxy gateway connecting end terminals and the 5G network. Sidelink can operate in different spectrum configurations, such as dedicated, in-band licensed, and unlicensed. It can also support a wide range of devices.

Some embodiments are directed to a user equipment (UE) configured for operation in a fifth-generation new radio (5G NR) network. In these embodiments, the UE may be capable of performing sidelink (SL) positioning measurements. In these embodiments, for performing the SL positioning measurements, the UE may decode a sidelink configuration information (SCI) received from a generation Node B (gNB). The SCI may include an information element that indicates configuration information for resources of a sidelink positioning reference signal (SL PRS) resource pool. The UE may also measure sidelink (SL) positioning reference signal (SL PRS) resources received from another UE based on the configuration information and may report measurements of the SL PRS resources within a measurement reporting delay time. The UE may be configured to report the measurements in a measurement report to the other UE or a location management function (LMF) of the network.

In some of these embodiments, the measurements include at least one of SL PRS reference signal received power (SL PRS-RSRP) and SL PRS reference signal received path power (SL PRS-RSRPP), although the scope of the embodiments is not limited in this respect.

In some embodiments, the UE may be configured to perform the measurements with measurement accuracy requirements for each SL-PRS resource measured.

In some embodiments, the UE may be configured to report the measurements in a measurement report to one of the other UE and a location management function (LMF) of the network. In these embodiments, the measurement report may be sent to the other UE via SL resources (e.g., secondary traffic channel (STCH)). In these embodiments, the measurement report may be sent to the LMF via network resources (e.g., dedicated control channel (DCCH)).

In some embodiments, the measurement reporting delay time comprises a time between when the measurement report is triggered and when the UE starts to transmit the measurement report. In these embodiments, when the UE may be configured to send the measurement report to the other UE, the measurement reporting delay time may exclude any delay caused by unavailability of the SL resources.

In some embodiments, the UE may be capable of performing SL positioning measurements comprising SL RSTD measurements, SL PRS-RSRP measurements, SL Rx-Tx time difference measurements, SL PRS-RSRPP measurements, SL AoA measurements, and SL RTOA measurements.

In some embodiments, the UE may be configured to monitor a physical sidelink control channel (PSCCH) to receive the SL PRS via a NR PC5 interface (see FIG. 3) within a single sidelink BWP on a single carrier.

In some embodiments, the UE may be configured to report the measurements in accordance with a measurement report mapping that is based on a configured parameter. In these embodiments, reported quantity values in the measurement report may correspond to ranges of measured quantity values.

In some embodiments, the reported quantity values are in accordance with a reporting granularity that may be configured based on the measurement accuracy requirements. In these embodiments, a first of the measurement accuracy requirements may be configured for the SL PRS-RSRPP measurements and a second of the measurement accuracy requirements may be configured for the SL RSTD measurements.

In some embodiments, when the UE is configured for operating in a NR sidelink resource pool configured for dynamic co-channel coexistence of a long-term evolution (LTE) sidelink and an NR sidelink, the UE may be configured to select a NR sidelink resource from a plurality of candidate NR sidelink resources of an NR sidelink resource pool for an NR sidelink transmission of a physical sidelink control channel (PSCCH) and an accompanying physical sidelink shared channel (PSSCH). In these embodiments, the selection of the NR sidelink resource based on one or more of Reference Signal Received Power (RSRP) thresholds received in an sidelink control information (SCI). In some embodiments, for the dynamic co-channel coexistence, time and frequency resources are shared between the NR sidelink and the LTE sidelink.

Some embodiments are directed to a non-transitory computer-readable storage medium that stores instructions for execution by processing circuitry of a user equipment (UE) configured for operation in a fifth-generation new radio (5G NR) network. In these embodiments, the UE may be capable of performing sidelink (SL) positioning measurements. In these embodiments, for performing the SL positioning measurements, the processing circuitry may decode a sidelink configuration information (SCI) received from a generation Node B (gNB), may configure the UE to measure sidelink (SL) positioning reference signal (SL PRS) resources received from another UE based on the configuration information and may configure the UE to report measurements of the SL PRS resources within a measurement reporting delay time.

Some embodiments are directed to a generation Node B (gNB) configured for operation in a fifth-generation new radio (5G NR) network. In these embodiments, for a User Equipment (UE) UE capable of performing sidelink (SL) positioning measurements, the gNB may encode a sidelink configuration information (SCI) for transmission to the UE. The SCI may be encoded to include an information element that indicates configuration information for resources of a sidelink positioning reference signal (SL PRS) resource pool. The gNB may receive a measurement report from the UE comprising measurements of sidelink (SL) positioning reference signal (SL PRS) resources received by the UE from another UE based on the configuration information. In these embodiments, the measurement report may be received within a measurement reporting delay time. In some embodiments, the measurements may include at least one of SL PRS reference signal received power (SL PRS-RSRP) and SL PRS reference signal received path power (SL PRS-RSRPP).

In some embodiments, the gNB may be configured to report the measurements in the measurement report to a location management function (LMF) of the network. In these embodiments, the measurements may be received from the UE and reported in accordance with a measurement report mapping that may be based on a configured parameter. In these embodiments, reported quantity values in the measurement report may correspond to ranges of measured quantity values.

Embodiments disclosed herein provide techniques to define the UE capability to support the reduced samples for positioning reference signal (PRS) measurement without a gap.

This objective is to specify the solutions to support of sidelink positioning (including ranging) in NR systems. Thus, from physical layer design perspective, the new measurement reference signal and procedure for positioning of sidelink may be designed by RAN1/2. The significant standardization works in RAN4 are also expected. For an example, the measurement reporting requirements for the different positioning method (e.g., SL-RTT, SL-AoA, and SL-TDOA, etc.) with the new SL-PRS measurement may be specified in Rel18. The following measurements with SL-PRS are defined. For SL PRS based RSRP measurement, these new measurements are defined in RAN1. SL PRS reference signal received power (SL PRS-RSRP) may be defined as the linear average over the power contributions (in W) of the resource elements that carry SL PRS reference signals configured for RSRP measurements within the considered measurement frequency bandwidth

With regard to the reference point for frequency range 1, the reference point for the SL PRS-RSRP may be the antenna connector of the UE. For frequency range 1, if receiver diversity may be in use by the UE, the reported SL PRS-RSRP value shall not be lower than the corresponding SL PRS-RSRP of any of the individual receiver branches. In these embodiments, the SL PRS reference signal received path power (SL PRS-RSRPP), may be defined as the power of the linear average of the channel response at the i-th path delay of the resource elements that carry SL PRS signal configured for the measurement, where SL PRS-RSRPP for the 1st path delay may be the power contribution corresponding to the first detected path in time. With regard to the reference point, for frequency range 1, the reference point for the SL PRS-RSRPP may be the antenna connector of the UE. For frequency range 1, if receiver diversity is in use by the UE, the reported SL PRS-RSRPP value shall not be lower than the corresponding SL PRS-RSRPP of any of the individual receiver branches.

Based on the new measurement metric, from RAN4 RRM perspective, embodiments described herein may include: Embodiment 1: The core and performance requirements for SL PRS-RSRP and SL PRS-RSRPP may be specified in Rel18. For SL-PRS based Azimuth of arrival (AoA) and zenith of arrival (ZoA) measurement, since the core requirements AoA in Rel 16 and 17 are absent, whether SL-AoA core requirements may be defined in Release 18 or a future release. Support both GCS and LCS for SL-PRS based Azimuth of arrival (AoA) and zenith of arrival (ZoA) measurement. FFS on the applicable scenario/service for AoA/ZoA relative to LCS without translation of the LCS to GCS. Embodiment 2: For SL-PRS based Azimuth of arrival (SL-PRS AoA) and zenith of arrival (SL-PRS ZoA) measurement, RAN4 can ONLY define the performance requirements (e.g. report mapping) for them. The requirements may or may not include an accuracy requirement.

For SL RTOA, the definition in RAN1 was agreed as: SL-PRS based RTOA T_{SL-RTOA} may be defined as the beginning time of SL subframe #i containing SL-PRS received from a UE, relative to the RTOA Reference Time. The SL RTOA reference time may be defined as T₀+t_{sL-FRS}, where T₀ may be the nominal beginning time of SFN 0 or DFN0. FFS on how to select between SFN 0 or DFN 0 for determination of TO. FFS: the source for the reference timing t_{SL-PRS}=(10n_{f}+n_{sf})×10⁻³, where n_{f} and n_{sf} are the SFN or DFN and the subframe number of the SL-PRS, respectively, FFS on how to select between SFN or DFN.

In Rel16, there are not any core requirements define for UL measurements (e.g. SRS based RTOA measurement). Regarding to the limit timeline and overloading works in RAN4 for this WI, embodiments herein may include: Embodiment 3: For SL-PRS based RTOA measurement, RAN4 may only define the performance requirements for them (e.g. report mapping and accuracy). And we also observed the definition SL-PRS based Rx-Tx measurement and SL RSTD is still open without agreements. However, in our view, it may be one of most significant measurements for positioning. Therefore, embodiments herein may include: Embodiment 4: The requirements for SL-PRS based Rx-Tx measurement and SL RSTD may be specified in Rel18. And the details can be FFS upon RAN1's agreements.

In the last RAN1 meeting, RAN1 agreed to not introduce SL PFL since there may be only a single SL BWP per a carrier. A SL PFL is not defined. SL positioning RS are defined directly with respect to and contained within a single SL BWP and carrier. In Rel16, the PRS measurement requirements are highly dependent with a PFL which is a collection of DL PRS Resource Sets across one or more TRPs which have
the same SCS and CP type
the same center frequency
the same point-A
the same configured DL PRS BW

For an example, UE was assumed to perform the PRS measurements sequentially per PFL and UE needs the measurement gap for the different PRS resource sets with a same PFL indeed. Observation 2: SL-PRS measurement requirements framework needs to be updated according to RAN1's agreements on SL PRS hierarchical structure (e.g. Positioning Frequency Layer (SL PFL), SL PRS resource sets, and SL PRS resources). Also RAN1 agreed the numerologies of SL PRS as: Support SCS values for SL PRS include: 15 kHz, 30 kHz, 60 kHz for FR1, and 60 kHz, 120 kHz for FR2, Which SCS values are required, and which ones are optional follow Rel-16 UE capabilities. From RAN4 perspective, it is suggested that: Embodiment 6: Core requirements of SL-PRS measurements may be applicable for all supported SCS per FR. But for the performance accuracy requirements, the different requirements can be defined per SCs or SCS groups.

### Measurement Reporting

In the last RAN1 meeting, RAN1 agreed to introduce LoS/NLOS indicator in sidelink positioning measurement report. LoS/NLoS indicator can be included in a sidelink positioning measurement report, considering different reporting targets (LMF and UE).

LOS/NLOS indicator specified in Rel-17 positioning may be reused as much as possible. No specification impact for how to set this indicator.

From RAN1 perspective, no performance requirements are expected to be defined for setting indicator in Rel-18. In Rel17, there may be obvious performance degradation in NLOS channel in comparison with these in LOS. Theoretically, the similar performance degradation because of multipath fading in NLOS can be observed. Observation 3: In Rel18, the performance degradation in NLOS channel in comparison with these in LOS may be expected.

Embodiment 7: RAN4 can FFS on the different the accuracy requirements under the difference channel conditions (LOS/NLOS). As described above, the requirements for SL Rx-Tx time difference, SL AoA/ZoA, SL RSRP/RSRPP, SL RSTD and SL RTOA should be defined in RAN4. One of the fundamental issues for these measurements may be the reporting granularity. Similarly, in Rel18 positioning, in order to support different using scenarios the dynamic range and resolution of timing measurements may have large difference for different application scenarios. Therefore, the reporting granularity for SL Rx-Tx time difference, SL RSTD and SL RTOA should be configurable.

Observation 4: In Rel-16 positioning, the reporting granularity for timing measurements (e.g. Rx-Tx time difference, RSTD and RTOA) can be configurable to support the different accuracy.

Embodiment 8: For SL positioning, the reporting granularity for SL Rx-Tx time difference, SL RSTD and SL RTOA should be configurable. For other no timing measurements which are tolerable on the measurement reporting granularity and smaller reporting range, (e.g. PRS RSRP, AoA/ZoA) we can use the fixed reporting granularity may be applied to SL AoA/ZoA. Proposal 9: The fixed reporting granularity can be applied to SL PRS RSRP and AoA/ZoA.

Further aspects of various embodiments herein may include:
Embodiment 1: In TS38.133 the measurement reporting delay requirements for SL PRS-RSRP and SL PRS-RSRPP are defined for all supported SCS per FR
Embodiment 2: In TS38.133 the measurement reporting delay requirements SL-PRS based Rx-Tx measurement and SL RSTD are defined for all supported SCS per FR
Embodiment 3: the different the accuracy requirements under the difference channel conditions (LOS/NLOS).
Embodiment 4: For SL positioning, the reporting granularity for SL Rx-Tx time difference, SL RSTD and SL RTOA should be configurable
Embodiment 5: The fixed reporting granularity can be applied to SL PRS RSRP and AoA/ZoA.

### EXAMPLES

1. A method to define UE behavior to support the positioning measurements in sidelink.
2. A method of example 1, where in UE are required to successfully report the sidelink PRS measurement results within a specific time duration.
3. A method of example 2, wherein these SL PRS measurements can be SL PRS-RSRP and SL PRS-RSRPP
4. A method of example 2, wherein these SL PRS measurements can be SL RSTD and SL Rx-Tx time difference.
5. A method of example 3, wherein the reporting accuracy can be independent on subcarrier spacing(SCS).
6. A method of example 4, wherein the reporting accuracy can be dependent on subcarrier spacing(SCS).
7. A method of example 4, wherein the reporting granularity can be configurable upon PRS parameters.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An apparatus for a user equipment (UE) configured for operation in a fifth-generation new radio (5G NR) network, the apparatus comprising: processing circuitry; and memory, the UE capable of performing sidelink (SL) positioning measurements,
wherein for performing the SL positioning measurements, the processing circuitry is to:
decode a sidelink configuration information (SCI) received from a generation Node B (gNB), the SCI including an information element that indicates configuration information for resources of a sidelink positioning reference signal (SL PRS) resource pool;
measure sidelink (SL) positioning reference signal (SL PRS) resources received from another UE based on the configuration information; and
report measurements of the SL PRS resources within a measurement reporting delay time,
wherein the measurements include at least one of SL PRS reference signal received power (SL PRS-RSRP) and SL PRS reference signal received path power (SL PRS-RSRPP).

2. The apparatus of claim 1, wherein the UE is configured to perform the measurements with measurement accuracy requirements for each SL-PRS resource measured.

3. The apparatus of claim 2, wherein the UE is configured to report the measurements in a measurement report to one of the other UE and a location management function (LMF) of the network,
wherein the measurement report is sent to the other UE via SL resources (e.g., secondary traffic channel (STCH)), and
wherein the measurement report is sent to the LMF via network resources (e.g., dedicated control channel (DCCH)).

4. The apparatus of claim 3, wherein the measurement reporting delay time comprises a time between when the measurement report is triggered and when the UE starts to transmit the measurement report, wherein when the UE is configured to send the measurement report to the other UE, the measurement reporting delay time excludes any delay caused by unavailability of the SL resources.

5. The apparatus of claim 4, wherein the UE is capable of performing SL positioning measurements comprising SL RSTD measurements, SL PRS-RSRP measurements, SL Rx-Tx time difference measurements, SL PRS-RSRPP measurements, SL AoA measurements, and SL RTOA measurements.

6. The apparatus of claim 5, wherein the processing circuitry is to configure the UE to monitor a physical sidelink control channel (PSCCH) to receive the SL PRS via a NR PC5 interface within a single sidelink BWP on a single carrier.

7. The apparatus of claim 6, wherein the UE is configured to report the measurements in accordance with a measurement report mapping that is based on a configured parameter,
wherein reported quantity values in the measurement report correspond to ranges of measured quantity values.

8. The apparatus of claim 7, wherein the reported quantity values are in accordance with a reporting granularity that is configured based on the measurement accuracy requirements,
wherein a first of the measurement accuracy requirements is configured for the SL PRS-RSRPP measurements and a second of the measurement accuracy requirements is configured for the SL RSTD measurements.

9. The apparatus of claim 2, wherein when the UE is configured for operating in a NR sidelink resource pool configured for dynamic co-channel coexistence of a long-term evolution (LTE) sidelink and an NR sidelink, the processing circuitry is configured to:
select a NR sidelink resource from a plurality of candidate NR sidelink resources of an NR sidelink resource pool for an NR sidelink transmission of a physical sidelink control channel (PSCCH) and an accompanying physical sidelink shared channel (PSSCH), the selection of the NR sidelink resource based on one or more of Reference Signal Received Power (RSRP) thresholds received in an sidelink control information (SCI).

10. The apparatus of claim 9, wherein for the dynamic co-channel coexistence, time and frequency resources are shared between the NR sidelink and the LTE sidelink.

11. A computer-readable storage medium that stores instructions for execution by processing circuitry of a user equipment (UE) configured for operation in a fifth-generation new radio (5G NR) network, the UE capable of performing sidelink (SL) positioning measurements,
wherein for performing the SL positioning measurements, the processing circuitry is to:
decode a sidelink configuration information (SCI) received from a generation Node B (gNB), the SCI including an information element that indicates configuration information for resources of a sidelink positioning reference signal (SL PRS) resource pool;
measure sidelink (SL) positioning reference signal (SL PRS) resources received from another UE based on the configuration information; and
report measurements of the SL PRS resources within a measurement reporting delay time,
wherein the measurements include at least one of SL PRS reference signal received power (SL PRS-RSRP) and SL PRS reference signal received path power (SL PRS-RSRPP).

12. The computer-readable storage medium of claim 11, wherein the UE is configured to perform the measurements with measurement accuracy requirements for each SL-PRS resource measured.

13. The computer-readable storage medium of claim 12, wherein the UE is configured to report the measurements in a measurement report to one of the other UE and a location management function (LMF) of the network,
wherein the measurement report is sent to the other UE via SL resources (e.g., secondary traffic channel (STCH)), and
wherein the measurement report is sent to the LMF via network resources (e.g., dedicated control channel (DCCH)).

14. The computer-readable storage medium of claim 13, wherein the measurement reporting delay time comprises a time between when the measurement report is triggered and when the UE starts to transmit the measurement report, wherein when the UE is configured to send the measurement report to the other UE, the measurement reporting delay time excludes any delay caused by unavailability of the SL resources.

15. The computer-readable storage medium of claim 14, wherein the UE is capable of performing SL positioning measurements comprising SL RSTD measurements, SL PRS-RSRP measurements, SL Rx-Tx time difference measurements, SL PRS-RSRPP measurements, SL AoA measurements, and SL RTOA measurements.

16. The computer-readable storage medium of claim 15, wherein the processing circuitry is to configure the UE to monitor a physical sidelink control channel (PSCCH) to receive the SL PRS via a NR PC5 interface within a single sidelink BWP on a single carrier.

17. The computer-readable storage medium of claim 16, wherein the UE is configured to report the measurements in accordance with a measurement report mapping that is based on a configured parameter,
wherein reported quantity values in the measurement report correspond to ranges of measured quantity values.

18. The computer-readable storage medium of claim 17, wherein the reported quantity values are in accordance with a reporting granularity that is configured based on the measurement accuracy requirements,
wherein a first of the measurement accuracy requirements is configured for the SL PRS-RSRPP measurements and a second of the measurement accuracy requirements is configured for the SL RSTD measurements.

19. An apparatus for a generation Node B (gNB) configured for operation in a fifth-generation new radio (5G NR) network, the apparatus comprising: processing circuitry; and memory,
wherein for a User Equipment (UE) UE capable of performing sidelink (SL) positioning measurements, the processing circuitry is configured to:
encode a sidelink configuration information (SCI) for transmission to the UE, the SCI including an information element that indicates configuration information for resources of a sidelink positioning reference signal (SL PRS) resource pool; and
receive a measurement report from the UE, the measurement report comprising measurements of sidelink (SL) positioning reference signal (SL PRS) resources received by the UE from another UE based on the configuration information, the measurement report being received within a measurement reporting delay time,
wherein the measurements include at least one of SL PRS reference signal received power (SL PRS-RSRP) and SL PRS reference signal received path power (SL PRS-RSRPP).

20. The apparatus of claim 19, wherein the processing circuitry is to configure the gNB to report the measurements in the measurement report to a location management function (LMF) of the network,
wherein the measurements are reported in accordance with a measurement report mapping that is based on a configured parameter, and
wherein reported quantity values in the measurement report correspond to ranges of measured quantity values.
